(19) United States
(12) Patent Application Publication
(10) Pub. No.: US 2013/0122896 A1
(43) Pub. Date: May 16, 2013

(54) METHOD AND DEVICE FOR PROVIDING COMMUNICATION TO USER EQUIPMENT

(71) Applicant: Zhaoning Jiang, Shanghai (CN)

(72) Inventor: Zhaoning Jiang, Shanghai (CN)

(21) Appl. No.: 13/520,871

(22) PCT Filed: Jan. 4, 2011
(86) PCT No.: PCT/CN11/70021

§ 371 Date: Jul. 6, 2012

(30) Foreign Application Priority Data
Jan. 8, 2010 (CN) 201010001461.2

(51) Int. Cl. H04W 80/00

(52) U.S. Cl. CPC H04W 80/00
USPC 455/426.1

(57) ABSTRACT

The invention proposes a technical solution of providing communication between the first user equipment and the second user equipment, wherein the first user equipment uses a first multi-touch communication protocol, and the second user equipment uses a second multi-touch communication protocol, and the method comprises: receiving multi-touch information which is based on the first multi-touch communication protocol from the first user equipment; converting the multi-touch information which is based on the first multi-touch communication protocol to multi-touch information which is based on the second multi-touch communication protocol; and sending the multi-touch information which is based on the second multi-touch communication protocol to the second user equipment. With the present invention, an effective solution of the communication between mobile phones using different multi-touch communication protocol is provided. The conversion of the multi-touch communication protocols can be implemented by an independent network apparatus, which simplifies the design of the user equipment, for example the mobile phone.

### FIELD OF THE INVENTION

The present invention relates to method and device for providing communication to user equipment.

### BACKGROUND OF THE INVENTION

Multi-touch technology is a technology that is jointly implemented by the human-computer interaction and hardware device, which can carry out human-computer interaction on the computer part without traditional input device(for example, mouse, keyboard, etc.) With the multi-touch technology, a touch screen (screen, desktop, wall, etc.) or touch panel can receive input information of multi points from the screen simultaneously.

Currently multi-touch technology is largely supported in mobile phones, for example Apple Inc., Samsung Group and Nokia Corporation have implemented multi-touch technology in human-computer interaction interface of their mobile phones.

### SUMMARY OF THE INVENTION

With more and more mobile phones having multi-touch functions, since different mobile phone vendors use different multi-touch communication protocols, it becomes an urgent problem to be settled about how to communicate between the mobile phones using different multi-touch communication protocols.

According to an embodiment of the present invention, there is provided a method of providing communication between a first user equipment and a second user equipment, wherein the first user equipment uses a first multi-touch communication protocol, and the second user equipment uses a second multi-touch communication protocol, and the method comprises: receiving multi-touch information which is based on the first multi-touch communication protocol from the first user equipment; converting the multi-touch information which is based on the first multi-touch communication protocol to multi-touch information which is based on the second multi-touch communication protocol; and sending the multi-touch information which is based on the second multi-touch communication protocol to the second user equipment.

According to another embodiment of the present invention, there is provided a providing device for providing communication between a first user equipment and a second user equipment, wherein the first user equipment uses a first multi-touch communication protocol, and the second user equipment uses a second multi-touch communication protocol, and the providing device comprises: a receiver for receiving multi-touch information which is based on the first multi-touch communication protocol from the first user equipment; a converter for converting the multi-touch information which is based on the first multi-touch communication protocol to multi-touch information which is based on the second multi-touch communication protocol; and a sender for sending the multi-touch information which is based on the second multi-touch communication protocol to the second user equipment.

With the method and device provided by the present invention, an effective solution of the communication between mobile phones using different multi-touch communication protocols is provided. Alternatively, the conversion of the multi-touch communication protocol can be implemented by an independent network device, which simplifies the design of the user equipment, for example the mobile phone.

### BRIEF DESCRIPTION OF THE DRAWINGS

By reading the detailed description of the non-restrictive embodiments with reference to the following drawings, other features, objects and advantages of this invention will become apparent.

FIG. 1 shows an application scenario according to a detailed embodiment of the present invention;

FIG. 2 shows a flow chart of a method of providing communication between a first user equipment and a second user equipment according to a detailed embodiment of the present invention;

FIG. 3 shows a block diagram of the providing device for providing communication between a first user equipment and a second user equipment according to a detailed embodiment of the present invention;

Wherein, same or similar reference numerals refer to the same or similar steps or means/device (module).

### DETAILED DESCRIPTION OF EMBODIMENTS

The detailed embodiments of the present invention will be described in details referring to the following drawings.

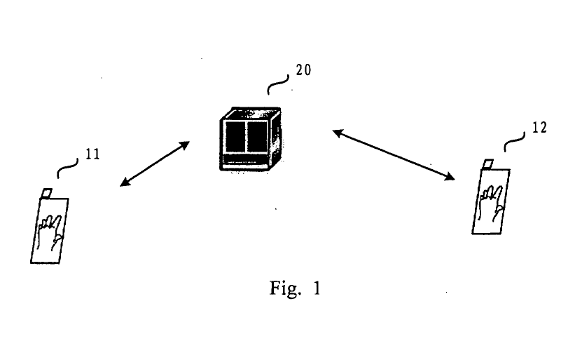

FIG. 1 shows an application scenario according to a detailed embodiment of the present invention. Wherein, the first user equipment 11 uses a first multi-touch communication protocol, and the second user equipment 12 uses a second multi-touch communication protocol, a network apparatus 20 performs protocol conversion of the multi-touch information for the first user equipment 11 and the second user equipment 12, so that the first user equipment 11 and the second user equipment 12 can understand its counterpart's multi-touch information, in order for an effective communication.

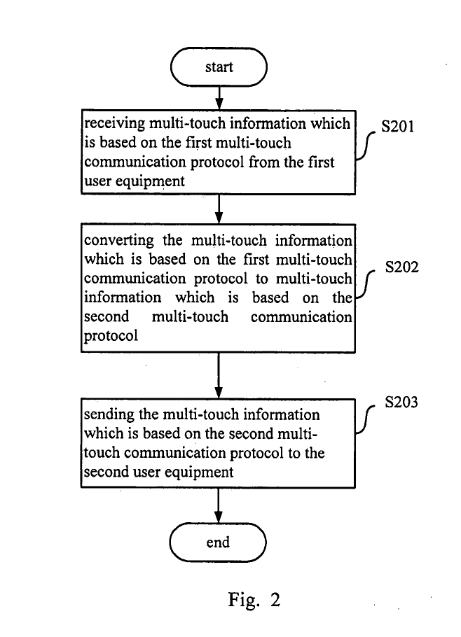

FIG. 2 shows a flow chart of a method of providing communication between the first user equipment and the second user equipment according to a detailed embodiment of the present invention. The method for network apparatus 20 in FIG. 1 to provide communication between the first user equipment 11 and the second user equipment 12 will be elucidated in combination with FIG. 1. Here, the first user equipment 11 and the second user equipment 12 can be user terminal equipments such as mobile phones, PDAs, fixed telephones that have multi-touch screen.

First, in step S201, the network apparatus 20 receives multi-touch information which is based on the first multi-touch communication protocol from the first user equipment 11. The network apparatus 20 can receive the multi-touch information of the first user equipment 11 via cable or wireless network. Alternatively, the multi-touch information may comprise the information that the multi-touch information is sent to the second user equipment 12. Alternatively, in another embodiment, the communication between the first user equipment 11 and the second user equipment 12 is set up in advance, and the network apparatus 20 acknowledges that the multi-touch information which is based on the first multi-touch communication protocol from the first user equipment 11 is destined to the second user equipment 12; and the multi-touch information which is based on the second multi-touch communication protocol from the second user equipment 12 is destined to the first user equipment 11.

It should be noted that the multi-touch information can comprise various information, in an embodiment, the multi-touch information comprises time and location information. For TUIO (Tangible User Interface Objects) protocol, the multi-touch information may comprise sessionID, classID, location, angle, motion vector, rotating vector, motion angle and rotating angle, etc. The detailed information related to TUIO can refer to Kaltenbrunner, M., Bovermann, T., Bencina, R., Costanza, E.: “TUIO—A Protocol for Table Based Tangible User Interfaces”. Proceedings of the 6th International Workshop on Gesture in Human-Computer Interaction and Simulation (GW 2005), Vannes, France, 2005, or http://www.tuio.org. For other private multi-touch communication protocol, the multi-touch information can be defined by the user equipment provider.

Then, in step S202, the network apparatus 20 converts the multi-touch information which is based on the first multi-touch communication protocol from the first user equipment 11 to the multi-touch information which is based on the second multi-touch communication protocol.

At last, in step S203, the network apparatus 20 sends the multi-touch information which is based on the second multi-touch communication protocol to the second user equipment 12. The network apparatus 20 can send the multi-touch information via cable or wireless network.

Optionally, before the step S202, the network apparatus 20 further obtains the information of multi-touch communication protocols used respectively by the first user equipment 11 and the second user equipment 12, and performs the protocol conversion of step S202 based on the information. In an embodiment, the information of the multi-touch communication protocol refers to the type of multi-touch communication protocol used by the user equipment. The network apparatus 20 acknowledges all kinds of multi-touch communication protocols, and can implement mutual conversion between them.

It should be noted that the method for the network apparatus 20 to obtain the information of multi-touch communication protocol respectively used by the first user equipment 11 and the second user equipment 12 are various.

In an embodiment, before the step S201, the first user equipment 11 and the second user equipment 12 both send a message to the network apparatus 20, the message respectively comprising the information of the multi-touch communication protocol respectively used by them. For example, the first user equipment 11 and the second user equipment 12 are both mobile phones having a multi-touch screen, and the user uses them to play network game. The network apparatus 20 is a network game server, the login messages that the first user equipment 11 and the second user equipment 12 respectively send to the network apparatus 20 comprise the information of the multi-touch communication protocol respectively used by them.

In another embodiment, after the network apparatus 20 receives the multi-touch information which is based on the first multi-touch communication protocol from the first user equipment 11, the network apparatus 20 sends two query messages respectively to the first user equipment 11 and the second user equipment 12, the two query messages being used to query the information of multi-touch communication protocols used by the first user equipment 11 and the second user equipment 12, based on which the protocol conversion of step S202 is then carried out.

In another embodiment, the multi-touch information which is based on the first multi-touch communication protocol from the first user equipment 11 comprises the information of the multi-touch communication protocol used by the first user equipment 11, then after the network apparatus 20 receives the multi-touch information which is based on the first multi-touch communication protocol from the first user equipment 11, it sends a query message to the second user equipment 12 to query the information of multi-touch communication protocol used by the second user equipment 12, based on which the in protocol conversion of step S202 is then carried out.

The method for the network apparatus 20 to obtain the information of multi-touch communication protocol respectively used by the first user equipment 11 and the second user equipment 12 is described above. In another embodiment, the network apparatus 20 does not need to obtain the information of multi-touch communication protocol respectively used by the first user equipment 11 and the second user equipment 12, and the information can be comprised in the multi-touch information which is based on the first multi-touch communication protocol received from the first user equipment 11.

Currently, the multi-touch communication protocol has various kinds, including the open TUIO protocol, the private protocol of each company, etc. The mutual conversion between the TUIO protocol and a specific private multi-touch information protocol is used as an example for elucidating the protocol conversion process.

Without loss of generality, suppose that the first user equipment 11 uses TUIO multi-touch communication protocol, and it uses s ix y as the multi-touch information format, wherein, s represents session ID, i represents class ID, x represents width location information, y represents height location information. The second user equipment 12 uses a private multi-touch communication protocol, and the multi-touch information format used by the second user equipment 12 is session:value Seq:value wid:value hei:value, wherein session represents sessionID, which is the ID related to specific application program, and different application program has different sessionID; Seq represents sequence information, and it indicates the sampling order of multi-touch parameter such as multi-touch locations, wid represents width location, and hei represents height location.

When the network apparatus 20 receives the multi-touch information 1 2 345 123 which is based on the TUIO multi-fouch communication protocol from the user equipment 11, it converts the multi-touch information 1 2 345 123 which is based on the TUIO multi-touch communication protocol into the format, session:1 Seq:2 wid:234 hei:123, of private protocol which is based on the second user equipment 12, and sends the converted format to the second user equipment 12, and vice versa.

The procedure for the network apparatus 20 to provide communication between the first user equipment 11 and the second user equipment 12, that is to say, the conversion procedure between multi-touch communication protocols are described in details taking the application scenario shown in FIG. 1 as an example. It should be noted that in some application scenarios, the function for converting multi-touch communication protocol in the network apparatus 20 can be implemented by the first user equipment 11 or the second user equipment 12.

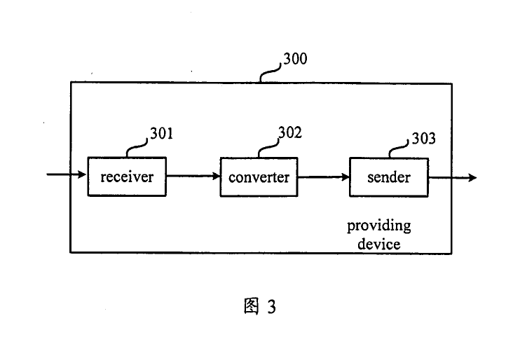

FIG. 3 shows a block diagram of the providing device 300 for providing communication between a first user equipment and a second user equipment according to a detailed embodiment of the present invention. The providing device 300 comprises a receiver 301, a converter 302 and a sender 303.

The working procedure for the providing device 300 in the network apparatus 20 in FIG. 1 to provide communication between the first user equipment 11 and the second user equipment 12 is described in details in combination with the FIG. 1.

First, the receiver 301 receives multi-touch information which is based on the first multi-touch communication protocol from the first user equipment 11. Alternatively, the multi-touch information may comprise the information that the multi-touch information is sent to the second user equipment 12. Alternatively, in another embodiment, the communication between the first user equipment 11 and the second user equipment 12 is set up in advance, and the network apparatus 20 acknowledges that the multi-touch information which is based on the first multi-touch communication protocol from the first user equipment 11 is destined to the second user equipment 12; and the multi-touch information which is based on the second multi-touch communication protocol from the second user equipment 12 is destined to the first user equipment 11.

It should be noted that the multi-touch information can comprise various information, in an embodiment, the multi-touch information comprises time and location information. For TUIO (Tangible User Interface Objects) protocol, the multi-touch information may comprise sessionID, classID, location, angle, motion vector, rotating vector, motion angle and rotating angle, etc. The detailed information related to TUIO can refer to Kaltenbrunner, M., Bovermann, T., Bencina, R., Costanza, E.: “TUIO—A Protocol for Table Based Tangible User Interfaces”. Proceedings of the 6th International Workshop on Gesture in Human-Computer Interaction and Simulation (GW 2005), Vannes, France, 2005, or http://www.tuio.org. For other private multi-touch communication protocol, the multi-touch information can be defined by the user equipment provider.

Then, the converter 302 converts the multi-touch information which is based on the first multi-touch communication protocol from the first user equipment 11 to the multi-touch information which is based on the second multi-touch communication protocol.

At last, the sender 303 sends the multi-touch information which is based on the second multi-touch communication protocol to the second user equipment 12.

Optionally, before the converter 302 performs protocol conversion, the providing device 300 further comprises a unit (not shown in FIG. 3), for obtaining the information of multi-touch communication protocols used respectively by the first user equipment 11 and the second user equipment 12, and the converter 302 performs the protocol conversion based on the information. In an embodiment, the information of the multi-touch communication protocol refers to the type of multi-touch communication protocol used by the user equipment. The converter 302 acknowledges all kinds of multi-touch communication protocols, and can implement mutual conversion between them.

It should be noted that the method for the unit for obtaining the information of multi-touch communication protocol respectively used by the first user equipment 11 and the second user equipment 12 are various, which is mentioned above and the details are omitted.

The procedure for providing device 300 in the network apparatus 20 to provide communication between the first user equipment 11 and the second user equipment 12 is described in details taking the application scenario shown in FIG. 1 as an example. It should be noted that in some application scenarios, the providing device 300 can be located in the first user equipment 11 or the second user equipment 12.

It should be noted that the above-mentioned embodiments illustrate rather than limit the invention It is intended that the invention includes all modifications and variations to the illustrated and described embodiments within the scope and spirit of the invention. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the device claims enumerating several units, several of these units can be embodied by one and the same item of hardware or software. The usage of the words first, second and third, et cetera, does not indicate any ordering. These words are to be interpreted as names.

1. A method of providing communication between a first user equipment and a second user equipment, wherein the first user equipment uses a first multi-touch communication protocol, and the second user equipment uses a second multi-touch communication protocol, and the method comprises:
A. receiving multi-touch information which is based on the first multi-touch communication protocol from the first user equipment;
B. converting the multi-touch information which is based on the first multi-touch communication protocol to multi-touch information which is based on the second multi-touch communication protocol; and
C. sending the multi-touch information which is based on the second multi-touch communication protocol to the second user equipment.

2. A method as claimed in claim 1, further comprising the step of:
obtaining information of multi-touch communication protocol used by the second user equipment.

3. A method as claimed in claim 2, further comprising the step of:
obtaining information of multi-touch communication protocol used by the first user equipment.

4. A method as claimed in claim 1, wherein the multi-touch information comprises time and location information.

5. A method as claimed in claim 1, wherein the first multi-touch communication protocol is TUIO protocol, and the second multi-touch communication protocol is private protocol.

6. A method as claimed in claim 1, wherein both the first multi-touch communication protocol and the second multi-touch communication protocol are private protocols.

7. A providing device for providing communication between a first user equipment and a second user equipment, wherein the first user equipment uses a first multi-touch communication protocol, and the second user equipment uses a second multi-touch communication protocol, and the providing device comprises:
a receiver for receiving multi-touch information which is based on the first multi-touch communication protocol from the first user equipment;
a converter for converting the multi-touch information which is based on the first multi-touch communication protocol to multi-touch information which is based on the second multi-touch communication protocol; and
a sender for sending the multi-touch information which is based on the second multi-touch communication protocol to the second user equipment.

8. A providing device as claimed in claim 7, further comprising the step of:
a unit for obtaining for obtaining information of multi-touch communication protocol used by the second user equipment.

9. A providing device as claimed in claim 8, wherein the unit for obtaining is further used for:
obtaining information of multi-touch communication protocol used by the first user equipment.

10. A providing device as claimed in claim 7, wherein the multi-touch information comprises time and location information.

11. A providing device as claimed in claim 7, wherein the first multi-touch communication protocol is TUIO protocol, and the second multi-touch communication protocol is private protocol.

12. A providing device as claimed in claim 7, wherein both the first multi-touch communication protocol and the second multi-touch communication protocol are private protocols.
